(19) United States
(12) Patent Application Publication
(10) Pub. No.: US 2018/0324328 A1
(43) Pub. Date: Nov. 8, 2018

(54) COLOR MAPPING WITH PHOSPHORESCENT MATERIALS

(71) Applicant: HP INDIGO B.V., Amstelveen (NL)

(72) Inventors: Biana Noikas, Rehovot (IL); Dror Kella, Ness Ziona (IL); Yaron Grinwald, Meitar (IL); Emad Masoud, Ness Ziona (IL); Adi Vinegrad, Rehovot (IL); Regina Guslitzer, Ness Ziona (IL)

(73) Assignee: HP INDIGO B.V., Amstelveen (NL)

(21) Appl. No.: 15/771,345

(22) PCT Filed: Mar. 18, 2016
(86) PCT No.: PCT/EP2016/056002

§ 371 Date: Apr. 30, 2018

(51) Int. Cl. H04N 1/60

(52) U.S. Cl. CPC H04N 1/6063; H04N 1/6011; H04N 1/6086

(57) ABSTRACT

In an example, processing apparatus includes an interface to receive input data comprising color data, a color mapping module to map at least one color of the input data to a print apparatus color space according to at least one mapping, and a preview module to generate a representation of a printed output of the print apparatus according to the mapping. The print apparatus color space may be defined based on print materials to be used by a print apparatus, wherein at least one print material comprises phosphorescent material. The preview module may generate a first image representing an externally illuminated printed output of the print apparatus, and a second image representing a phosphorescing printed output of the print apparatus in a low light environment.

### BACKGROUND

A color gamut may comprise a range of colors producible or available in a printing process or with a given device. Thus, different color reproduction techniques, different printing systems and different display devices may all have different color gamuts.

Color mappings are used to map between color spaces and color gamuts. For example, when printing an image, the data representing that image may describe a first range of colors in a first color space, for example in terms of reds, greens and blues (an RGB color space), but it may be intended to print the image using set of colors from a different color space, such as Cyan, Yellow, Magenta and Black (a CYMK color space), and using colors which are within the color gamut of a particular print apparatus. A mapping, for example embodied in a lookup table, may link the two color spaces such that a particular combination of colors of one color space can be used to reproduce or represent the colors from another color space.

### BRIEF DESCRIPTION OF DRAWINGS

Non-limiting examples will now be described, with reference to the accompanying drawings, in which:

FIG. 1 is a schematic representation of processing apparatus according to one example;

FIG. 2 is a schematic representation of processing apparatus according to another example;

FIG. 3 is another example method for printing a printed output;

FIG. 4 is an example method for characterising a low light color gamut;

FIG. 5 is an example method for determining a print material combination; and

FIG. 6 is an example method for printing a printed output.

### DETAILED DESCRIPTION

Some examples herein refer to print materials comprising phosphorescent material. Such phosphorescent material may be excited, for example using an excitation energy source such as a light source, a heat source or a particle source to provide a particle bombardment. Such excitation may ‘charge’ the phosphorescent material within the print materials. This places charges such as electrons within the molecules of the phosphorescent material into an excited state. This excited state ‘decays’ into a ground state at a later time with the emission of a photon, providing phosphorescence. Some examples relate to building color gamuts based on print material sets which include print materials comprising phosphorescent material. Some examples relate to mapping colors to a color space based on print materials which may comprise phosphorescent materials.

FIG. 1 is an example of processing apparatus 100 comprising an interface 102, a color mapping module 104 and a preview module 106.

The interface 102 is to receive input data 108 comprising color data. For example, the input data may describe or specify at least one color. In an example, the input data 108 may for example be an image such as a digital image and may be uploaded to the processing apparatus 100, or may be retrieved from a previously generated image set contained on a storage media, or retrieved from a remote storage location, such as an online application, using the Internet. In other examples, the input data 108 may comprise object model data, for example for generating an object using three dimensional printing (also termed ‘additive manufacturing’) techniques, the object model data describing at least one color for an object to be printed.

The color mapping module 104 is to map the color(s) of the input data 108 (which in the example of FIG. 1 represents an image) to a print apparatus color space according to at least one mapping (which may be a predetermined mapping), the print apparatus color space being defined based on print materials to be used by a print apparatus, wherein at least one print material comprises phosphorescent material. In some example, the print materials comprise at least one colorant, such as an ink or a toner. In examples associated with three dimensional printing, the print materials may comprise a build material which is solidified to form an object.

The preview module 106 generates a representation of a printed output (for example, a printed image or an object) of the print apparatus according to the mapping. More particularly, the preview module 106 generates a first image 110 representing a printed output of the print apparatus when externally illuminated, and a second image 112 representing that printed output as it would appear when phosphorescing in a low light environment, i.e. a representation of a phosphorescing image or object. As the colors produced in the illuminated and the phosphorescing printed output may be different, the output images 110, 112 may appear different, for example, the same color described in the color data of the input data may be represented differently (for example, with a different colorimetry) in the first image 110 than in the second image 112 (as illustrated with different shading representations in FIG. 1).

This allows the user to visualise ‘dark’ and ‘light’ (for example, night time and day time) versions of an output which may be printed by the print apparatus. This in turn may allow a user to, for example, alter a mapping (or a set of mappings) and view the effect on both the images, such that an intended effect in both light conditions may be seen. In some examples, the light level in the low light environment is sufficiently low such that phosphorescence is a significant, or even the dominant, light source.

In one example, the print apparatus may have a source of a plurality of separate print materials, for example, comprising print materials which are to contribute to the colorimetry of at least one of the externally illuminated and phosphorescing printed output. An example print apparatus may comprise a set of print materials which predominantly contribute to the appearance of the printed output when illuminated and a set of print materials which predominantly contribute to the appearance of the printed output when phosphorescing. However, a single print material may contribute to the colorimetry of both of at least one of the externally illuminated and phosphorescing printed output (noting that the light reflected from such print materials may be different in color to the light emitted thereby due to phosphorescence).

In one example, a print apparatus may comprise a set of print materials comprising CYMK inks and also have a set of inks which phosphoresce to produce (at least near) red green and blue light, referred to herein as R_{P}, G_{P} and B_{P} inks. In such an example, the print apparatus color space may be a 7-dimensional space, each dimension associated with one of the inks. For example the mapping of the mapping module into the print apparatus color space may indicate an amount of each available print material to be applied to a region of a substrate in order to represent a portion of the input data having a particular color in both the illuminated and the low light environment.

In an example, in which the print apparatus comprises a set of inks comprising an CYMKR_{P}G_{P}B_{P} ink set, the color mapping module 104 may map the color(s) of the input data to CYMKR_{P}G_{P}B_{P} color space, and the preview module 106 may generate a preview of how the printed output (when printed) would appear when illuminated, for example in daylight, and when in a low light environment such that the printed output phosphoresces. As is further discussed below, the application of CYMK ink(s) may impact the colors of the phosphorescing printed output and the phosphorescent inks may impact the colors of the illuminated printed output. In some examples, the mapping may specify, or depend on, an order in which print materials are applied to a substrate.

This CYMKR_{P}G_{P}B_{P} set of print materials (in this example, colorants) is given by way of example. Other print material sets may comprise a subset of these colorants, different and/or additional inks, such as any or any combination of light cyan (c), red (R), Green (G), violet (V), light magenta (m), fluorescent inks (example fluorescent pink, a fluorescent yellow and a fluorescent magenta, and the like), other phosphorescent colors and/or at least one custom color. In examples of three dimensional printing, the print materials may comprise a build material comprising phosphorescent material.

In some examples, the preview module 106 may generate a preview in more than one illumination condition. For example, if the print material set comprises at least one fluorescent material, there may be a ‘daylight’ illuminated preview image and an ultraviolet illuminated preview image, which may differ. In such examples, the preview apparatus may generate three (or more) preview images.

In some examples, the color mapping module 104 maps the color(s) of the input data to a device independent color space and from the device independent color space to the print apparatus color space. Mapping into a device independent color space may reduce a number of explicit mappings into the print apparatus color space to be developed or stored. Alternatively, a set of mappings of each of a plurality of source color spaces into the print apparatus color space may be specified. For example, the device independent color space may be sRGB, Adobe RGB, or may be some other color space, for example a color space which uses an International Commission on Illumination (CIE) color model. Other color space models include Hue-Saturation-Value (HSV), Hue-Saturation-Lightness (HSL), or the like.

In some examples, the color mapping module 104 maps the colors of the input data to the print apparatus color space according to at least one condition. For example, a condition may comprise that hues should be conserved (such that greens in input data are green in both environments), or that color diversity should be maximised, or that edges should be preserved. In some examples, the mapping may be according to user-specified conditions. In some examples, there may be more than one condition, and the conditions may have a priority order. It may be that the same condition applies to both the illuminated and phosphorescent output colors, or it may be that different considerations apply according to whether the printed output is to be viewed in an illuminated or low-level light environment. In some examples, therefore, it may be the case that hue (or some other printed output quality, which may be an appearance quality) in intended to be consistent in both an illuminated and low-level light environment. This may for example mean that an image portion of an input image, for example, is green in both the illuminated and low-level light environment, but the colorimetry of that green may differ between the environments. In some examples, the difference in colorimetry (or some other metric) may be minimised. In other examples, it may be that, for example, that a mapping is intended to preserve hue in the illuminated printed output and to enhance color diversity in the phosphorescing printed output.

The input data 108 may therefore be processed for printing using the color mapping module 104. The resulting mappings may be used to determine control data for a print apparatus such as an inkjet print apparatus, a laser print apparatus, line print apparatus, a solid ink print apparatus, or a digital print apparatus, which may print the printed output onto any substrate, for example any variety of paper (lightweight, heavyweight, coated, uncoated, paperboard, cardboard, etc.), films, foils, textiles, fabrics, plastics or the like. In other examples, the mappings may be used in generating control data for a three dimensional object, for example using three dimensional printing techniques. The processing apparatus 100 may for example comprise a personal computer, a laptop computer, a desktop computer, a digital camera, a personal digital assistance device, a cellular phone, or some other processing apparatus. In some examples, the print apparatus 208 may comprise a three dimensional printing apparatus.

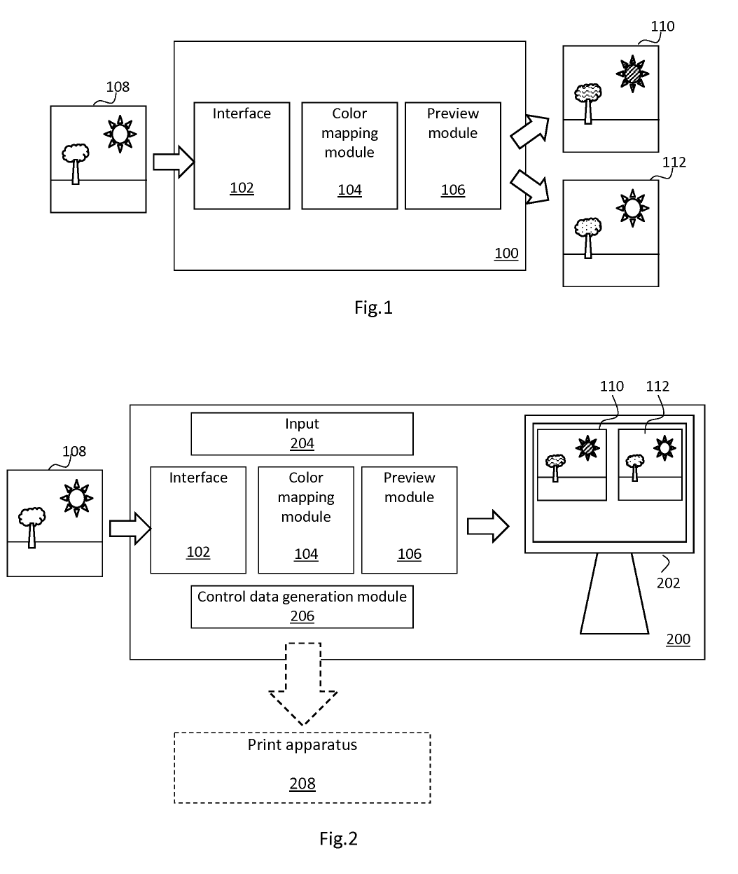

FIG. 2 illustrates an example processing apparatus 200 comprising the interface 102, color mapping module 104 and preview module 106 as described above. In this example, the processing apparatus 200 further comprises comprising a display output 202 (in this example a display screen) to display the first 110 and second 112 image and an input 204 for receiving user instructions to modify the mappings of the color mapping module 104. As noted above, this may allow a user to tailor the mappings with a view to how this may impact the appearance of a printed output in an illuminated and a low light environment. The processing apparatus 200 further comprises a control data generation module 206 to generate control data to print the printed output.

In some examples, the processing apparatus 200 may be associated with (for example, be in communication with, or comprise part of) a print apparatus 208, and the print apparatus 208 may print the printed output according to the control data generated by the control data generation module 206. In some examples, this may be a print apparatus 208 which uses offset printing. In a particular example, the print apparatus 208 may be a liquid electro-ink print apparatus. Such print apparatus 208 may produce ink layers which are applied to the surface of a substrate. As the layer is substantially ‘dry’ when applied to the substrate, the ink does not tend to sink into a substrate, even if the substrate is an absorbent substrate such as paper or card and thus photo-luminescence (e.g. fluorescence and/or phosphorescence) produced thereby is not significantly absorbed by the substrate. In addition, the layers of ink in such apparatus may be relatively thin and thus may not unduly restrict the luminescence of a layer which is covered by at least one other ink layer.

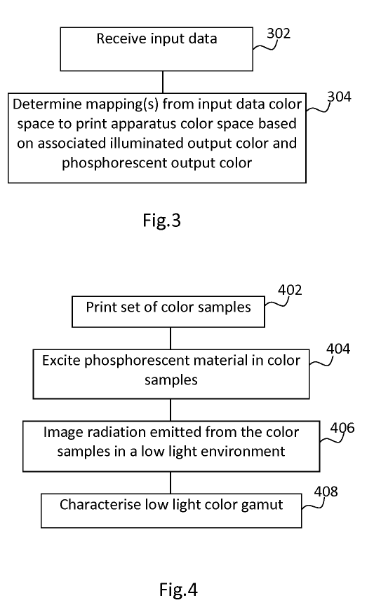

FIG. 3 is an example of a method comprising, in block 302, receiving input data. Block 304 comprises determining a mapping from input data color space to a print apparatus color space, wherein each color in the print apparatus color space is associated with at least one print material of a print apparatus, and at least one print material or combination of print materials of the print apparatus is associated with an illuminated output color and a phosphorescent output color. In this example, determining the mapping comprises determining a mapping based on the associated illuminated output color and phosphorescent output color.

For example, this may comprise determining a mapping according to at least one condition for a mapping into a color space. As discussed above, for example, a condition may comprise that hues in should be conserved, that color diversity of a source image/object should be preserved or maximised, that edges should be preserved, or the like and/or the conditions may be user-specified. In some examples, there may be more than one condition, and the conditions may have a priority order. It may be that the same condition applies to both the illuminated and phosphorescent output colors, or it may be that different considerations apply according to whether the printed output is to be viewed in an illuminated or low-level light environment.

In some examples, the method of FIG. 3 may be carried out by at least one processor, for example by the processing apparatus 100, 200 of FIG. 1 or FIG. 2 (for example, by the color mapping module 104).

Where more than one illuminated color gamut has been modelled, the mapping may be determined based on the plurality of associated illuminated output colors and the phosphorescent output color.

In some examples, the method further comprises determining a color separation to print a representation of the input data, the color separation comprising, for each of the print materials of the print apparatus, an indication of at least one location at which a colorant is to be applied in printing a printed output. The method may further comprise printing a printed output using the print materials specified by the mapping and/or color separation.

FIG. 4 shows a method, which may for example be at least in part a computer implemented method, of characterising a low light color gamut. In some examples, such a low light color gamut may be used in determining the colorimetry of a print material combination comprising at least on print material comprising phosphorescent material. In block 402, a set of color samples are printed. Each color sample is printed using one or a combination of print materials, wherein at least one of the print materials comprises phosphorescent material. In some examples, all of the color samples comprise at least some phosphorescent material. In some examples, at least one sample does not contain phosphorescent material (as will become apparent hereinafter, such sample(s) could provide a ‘black’ vertex of a color gamut). The color samples may be printed onto any substrate, for example any variety of paper (lightweight, heavyweight, coated, uncoated, paperboard, cardboard, etc.), films, foils, textiles, fabrics, plastics, powdered material (for example for three dimensional printing) or the like. In some example, the substrate may be varied, for example using different build materials for three dimensional printing (at least one of which may comprise phosphorescent materials in some examples). The color samples may comprise a plurality of color ‘patches’, each intended to represent a uniform color, and each being representative of a particular print material or print material combination. In some examples, at least a subset of the set of color samples may be printed on a common substrate to provide a test printed output.

In some examples, the color samples represent a cross section of colorant coverages which can be printed by a particular, or a particular class or type, of print apparatus. For example, such a print apparatus may comprise an offset printer, for example a digital offset printer which may print using an ink or toner. In some examples, the ink or toner may comprise electrically charged particles. In a particular example, the color samples may be printed using a liquid ink comprising charged pigmented and/or phosphorescent particles which are suspended in a liquid carrier. A particular print apparatus (or class or type of print apparatus) may be able to combine print materials in predetermined combinations (which in some examples may be associated with a substrate used). The color samples may comprise a range of print materials which span the set of possible combinations. In other words, the color samples may cover the space of possible colorant (e.g. ink or toner) coverages and combinations of the various print materials, which may assist in building a color gamut. In some examples, the set of color samples comprises at least substantially all the printable combinations. In other examples, the set of color samples may be a subset of the printable combinations, which may for example be well-distributed (for example, substantially evenly distributed) throughout the set of possible combinations. In some examples, an amount of colorant may be varied on an incremental basis between samples.

Block 404 comprises exciting the phosphorescent material in the color samples, for example using an excitation energy source such as a light source, a heat source or a particle source to provide a particle bombardment. Such excitation may ‘charge’ the phosphorescent material within the color samples resulting in the later emission of a photon, providing phosphorescence. In some examples, the set of color samples may be charged as a set, in subsets, or individually.

Block 406 comprises imaging the radiation emitted from the color samples in a low light environment. In some examples, the light level in the low light environment is sufficiently low such that phosphorescence is a significant, or even the dominant, light source. The imaging may for example be carried out using any imaging apparatus, for example a camera, which may be a digital camera, or a spectrophotometer, or the like. In some examples, the set of color samples may be imaged as a set, in subsets, or individually.

Block 408 comprises characterising, using at least one processor, a low light color gamut based on the colors of the emitted radiation. This may allow a relationship between the phosphorescent light and colorimetry to be established. The range in the measured colorimetries may then be used to characterise the low light color gamut. In an example, the low light color gamut may be expressed for example using CIEXYZ colorimetries.

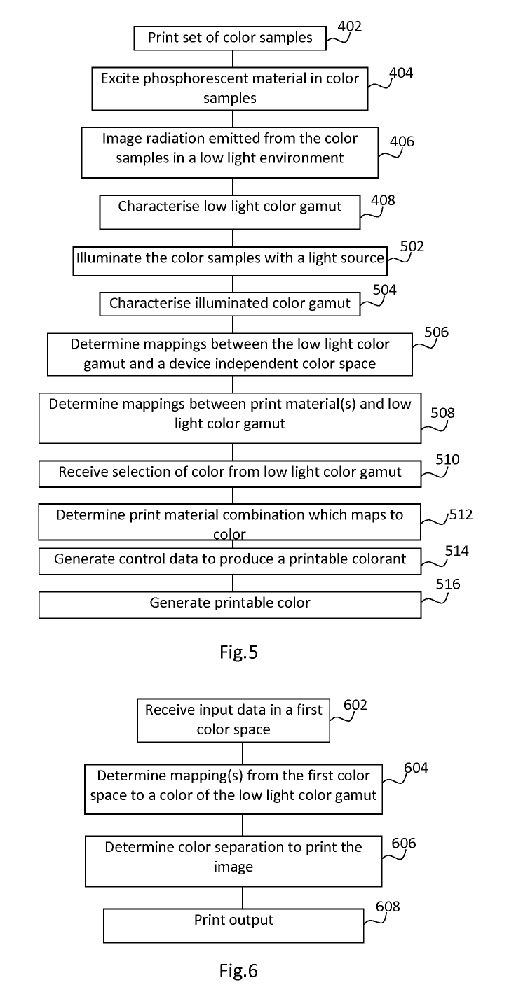

FIG. 5 is another example of a method, in which blocks 402 to 408 are as described in relation to FIG. 4. The method further comprises, in block 502, illuminating the color samples and, in block 504, characterising, using at least one processor, an illuminated color gamut based on light returned from the color samples. In some examples, the illumination may be daylight. In other examples, the illumination may be provided by a light source, for example emitting white light, or any other predetermined light color. In some examples, the light source may comprise ultraviolet light. The use of ultraviolet light may for example result in any fluorescent behaviour of the color samples being captured. If at least one print material used contains fluorescent material, this may also affect the light returned from the color samples under other light conditions, for example it may cause some colors to appear brighter in daylight than would otherwise be the case if there was no fluorescent material.

Block 506 comprises determining, using at least one processor, a plurality of mappings between the low light color gamut and a device independent color space. For example, the device independent color space may be sRGB, Adobe RGB, or may be some other color space, for example a color space which uses an International Commission on Illumination (CIE) color model. Other color space models include Hue-Saturation-Value (HSV), Hue-Saturation-Lightness (HSL), or the like.

Block 508 comprises, determining, using at least one processor, a plurality of mappings between print materials and combinations of print materials and the low light color gamut. The print material and combinations of print materials may provide, or be used to define, a print apparatus color space associated with the print apparatus. A print apparatus color space may be defined with reference at least one print material, which may be colorants such as inks and toners of a print apparatus. For example, the color space may be an n-dimensional space, where n is the number of available print materials. The print apparatus may for example be a specific print apparatus, or a class of print apparatus. For example, a color in the print apparatus color space may be defined in terms or amounts, or relative amounts, of each of the print materials to be applied to a substrate to allow the color to be perceived.

For example, a print apparatus may be a print apparatus which comprises a set of inks, for example comprising inks which phosphoresce to produce (at least near) red green and blue light, referred to herein as R_{P}, G_{P} and B_{P}. Therefore, a mapping between print materials and combinations of print materials and the low light color gamut may comprise a mapping from R_{P}, G_{P} and B_{P} inks and combinations thereof with different amounts (or relative amounts) of the R_{P}, G_{P} and B_{P} inks, to the colorimetries of the low light color gamut.

Mappings may also be determined to the illuminated color gamut. In some examples, the phosphorescent inks (for example, R_{P}, G_{P} and B_{P} inks) may be associated with a color when illuminated, i.e., the inks and combinations thereof may contribute to the colors in the illuminated color gamut (in other examples, they may be transparent). Therefore, a mapping between print materials and combinations of print materials and the illuminated color gamut may comprise a mapping from R_{P}, G_{P} and B_{P} and combinations thereof to the colorimetries of the illuminated color gamut (i.e., the colorimetries of light returned from those inks when illuminated). In some examples, in addition to at least one phosphorescent ink, a print apparatus may be provided with other colorants or print materials. To consider a particular example, a print apparatus may be provided with Cyan, Yellow, Magenta and Black inks associated with a CYMK color space.

It may be noted that printed inks contributing to the illuminated color gamut may combine (at least substantially) according to ‘subtractive’ color mixing. For example, a color to be achieved is mapped to the print materials to apply in order that the light reflected from the substrate and through the inks produces that color. However, phosphorescent inks emit light and therefore the colors provided by phosphorescent materials may combine according to additive color mixing.

In one example, the print apparatus may have a source of a plurality of separate print materials, for example, comprising both print materials which include phosphorescent materials, and those which do not, for example, CYMK inks and R_{P}, G_{P} and B_{P} inks. In some examples, phosphorescent print materials may be transparent. However, a single print material may contribute to the colorimetry of both an illuminated color gamut and the low light color gamut, for example comprising both pigment and phosphorescent material (and noting that the light reflected from such inks may be different in color to the light emitted thereby due to phosphorescence), as further detailed below. This may mean that mappings from the device color space to the illuminated color gamut are mappings from CYMKR_{P}G_{P}B_{P} color space to the illuminated color gamut. Similarly, the application of CYMK ink(s) may impact the colors in the low light color gamut, in which case mappings from the device color space to the low light color gamut may be mappings from CYMKR_{P}G_{P}B_{P} color space to the low light color gamut. Other ink set may comprise additional inks, such as any or any combination of light cyan (c), red (R), Green (G), violet (V), light magenta (m), fluorescent inks (example fluorescent pink, a fluorescent yellow and a fluorescent magenta, and the like), other phosphorescent colors and/or at least one custom color.

In some examples, the order in which the print materials are printed may reduce any effect of non-phosphorescent print materials on the phosphorescent print materials, for example by printing non-phosphorescent print materials first followed by phosphorescent print materials (assuming the printed output is to be viewed from ‘on top’—the reverse order may be used if, for example, a resultant printed output image is intended to be viewed through a substrate such as a transparent substrate). While this order could be reversed, so as to reduce any effect of phosphorescent print materials on the non-phosphorescent print materials, this may also result in the non-phosphorescent print materials blocking at least a portion of the phosphorescent light. In other examples, phosphorescent print materials may be printed as a sub-layer to illuminate an overlaid (for example partially transparent) layer. For example, the sub-layer may be an interior layer of a three-dimensional printed object.

More than one mapping may be developed (i.e. there may be a mapping between an input or device independent color space and more than one possible output color in an illuminated and/or low light gamut). This may allow a selection to be made between mappings, for example based an intended impression of a printed output.

As noted above, in some examples, the set of color samples may be a subset of the possible print material combinations printable by a print apparatus. In such examples, there may be colors in at least one gamut for which the mapping is inferred, for example based on an interpolation, rather than being an explicit mapping based on the color samples. For example, the combination of print materials to produce a color for which lies between two colors for which an explicit mapping exists may be determined by determining the average of the quantities of each of the print materials in the explicit mappings. In some examples, a mapping between this color and the interpolated combination may be predetermined.

In some examples, such mappings may be developed and/or used by the color mapping module 104 described in relation to FIG. 1 above.

Block 510 comprises receiving a selection of a color of the low light color gamut. In block 512, a print material combination which maps to the selected color is determined and block 514 comprises generating control data to produce a printable colorant comprising the determined print material combination. Block 516 comprises generating the printable colorant. This may comprise, for example, mixing existing colorants, or mixing particles to be used in providing print materials. This therefore allows a ‘custom colorant’ to be created. Such colors (which may for example be termed ‘spot colors’) may be used to create a consistent color with less colorant. For example, it may be that a particular color can be reproduced by applying three different colorants: this may comprise three layers, each of which may take time and energy to apply, and may have a minimum depth. If a custom colorant is provided, this may be printed in a single printed output. Therefore, if a particular color is to be used regularly or in large quantities (for example, because it comprises a ‘corporate color’ of an entity, and will appear on all printed documents produced for that entity), a spot color may be created to save time, energy use and/or resources associated with printing that color. In this example, the color is a phosphorescent color, and therefore block 516 may create a ‘spot’ color relating to the low light color gamut.

In practice, if a spot color defined using an interpolation of explicit mappings, a test sample of the color may be printed and the colorimetry thereof determined as the changes in colorimetry associated with changes in colorant amounts may be non-linear.

FIG. 6 is an example method, which may for example be at least in part a computer implemented method, of printing an image to provide an intended effect in low light. Block 602 comprises receiving input data in a first color space. For example this may be a device independent color space, or may be an image capture color space, or a display device color space, or any other color space. Block 604 comprises determining, for at least one color of the input data, a mapping from the first color space to a color of the low light color gamut. For example, this may comprise mapping all of the colors of input data to similar (in some examples, the closest existing color) in the low light color gamut. Such a color mapping may be intended to preserve at least one parameter of the input data, for example, to preserve hue, color variability or the like. In other examples, the mapping may be user defined (for example, such that a color in the input data matches to a different color in the low light color gamut).

Block 606 comprises determining a color separation to print the printed output, the color separation comprising, for each of a plurality of print materials comprising colorants available at a print apparatus, an indication of the location or locations at which that colorant is to be applied in printing a printed output. This may utilise mappings between a device color space and the low light color gamut, for example as described in relation to block 508 or block 302 above. Such a mapping may determine, on a pixel by pixel basis, which print materials are to be present at that pixel and the relative or absolute amounts of each colorant. This may for example specify a number of drops of a particular colorant to apply in the region of that pixel, or a number of layers of a particular colorant to be applied to that pixel (for example in an offset printing methods). This is then used to define a color separation, i.e. at least one ‘map’ for use in applying each colorant to be used in printing a printed output. These ‘maps’ taken together define the color separation of the printed output. Viewed another way, the color separation is a representation of the input data in the device color space, in which, for example, an image is divided into layers, each layer being associated with a particular one of the available colorants.

Block 608 comprises printing a printed output according to the color separation.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices (for example, the color mapping module 104, preview module 106 and control data generation module 206) may be implemented by a processor executing machine readable instructions stored in a memory, or a processor operating in accordance with instructions embedded in logic circuitry. The term ‘processor’, ‘processing apparatus’ and ‘processing circuitry’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow in the flow charts and/or block in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited solely by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. Processing apparatus comprising:
an interface to receive input data comprising color data;
a color mapping module to map at least one color of the input data to a print apparatus color space according to at least one mapping, the print apparatus color space being defined based on print materials to be used by a print apparatus, wherein at least one print material comprises phosphorescent material; and
a preview module to generate a representation of printed output of the print apparatus according to the at least one mapping, wherein the preview module is to generate a first image representing an externally illuminated printed output of the print apparatus, and a second image representing a phosphorescing printed output of the print apparatus in a low light environment.

2. Processing apparatus according to claim 1 further comprising a display output to display the first and second image.

3. Processing apparatus according to claim 1 further comprising an input to receive user instructions to modify at least one mapping of the color mapping module.

4. Processing apparatus according to claim 1 further comprising a control data generation module to generate control data to print the printed output.

5. Processing apparatus according to claim 1 in which the color mapping module is to map the colors of the input data to a device independent color space and from the device independent color space to the print apparatus color space.

6. A method comprising:
receiving input data; and
determining, using at least one processor, at least one mapping from an input data color space to a print apparatus color space, wherein each color in the print apparatus color space is associated with at least one print material of a print apparatus, and at least one print material or combination of print materials of the print apparatus is associated with an illuminated output color and a phosphorescent output color; and
wherein determining the mapping comprises determining a mapping based on the associated illuminated output color and phosphorescent output color.

7. A method according to claim 6 further comprising:
determining a color separation to print a representation of the input data, the color separation comprising, for the print materials of the print apparatus, an indication of at least one location at which a print material is to be applied in printing a printed output.

8. A method according to claim 6 further comprising printing a printed output using the print materials specified by the mapping.

9. A method, comprising:
printing a set of color samples, wherein each color sample is printed using one or a combination of print materials, and wherein at least one of the print materials comprises phosphorescent material;
exciting the phosphorescent material in the color samples;
imaging radiation emitted from the color samples in a low light environment; and
characterising, using at least one processor, a low light color gamut based on the colors of the emitted radiation.

10. A method according to claim 9 further comprising:
Illuminating the color samples; and
characterising, using at least one processor, an illuminated color gamut based on light returned from the color samples.

11. A method according to claim 9 further comprising determining, using at least one processor, a plurality of mappings between the low light color gamut and a device independent color space.

12. A method according to claim 9 further comprising determining, using at least one processor, a plurality of mappings between print materials and combinations of print materials and the low light color gamut.

13. A method according to claim 12 further comprising:
receiving a selection of a color of the low light color gamut;
determining a print material combination which maps to the color; and
generating control data to produce a printable colorant comprising the determined print material combination.

14. A method according to claim 13 further comprising generating the printable colorant.

15. A method according to claim 9 further comprising:
receiving input data in a first color space;
determining, for at least one color of the input data, a mapping from the first color space to a color of the low light color gamut;
determining a color separation to print a representation of the input data, the color separation comprising, for each of a plurality of print materials available as a print material at a print apparatus, an indication of at least one location at which that print material is to be applied in printing a printed output; and
printing a printed output according to the color separation.
